(19) United States
(12) Patent Application Publication
(10) Pub. No.: US 2007/0055464 A1
(43) Pub. Date: Mar. 8, 2007

(54) System and method for providing a compositional measurement of a mixture having entrained gas

(76) Inventor: Daniel L. Gysling, Glastonbury, CT (US)

Correspondence Address: CiDRA Corporation, 50 Barnes Park North, Wallingford, CT, 06492, US

(21) Appl. No.: 11/506,538

(22) Filed: Aug. 17, 2006

Related U.S. Application Data
(60) Provisional application No. 60/709,321, filed on Aug. 17, 2005.
(60) Provisional application No. 60/716,395, filed on Sep. 13, 2005.

(51) Int. Cl. G01F 23/00

(52) U.S. Cl. 702/50

(57) ABSTRACT

A method and apparatus for determining at least one characteristic of a fluid flowing within a pipe is provided, wherein the fluid includes a gas component and a liquid component. The method includes determining if the gas component is present in a predefined region of the pipe, generating fluid data responsive to whether the gas component is present in the predefined region of the pipe and processing the fluid data to identify the at least one characteristic of the fluid.

### CROSS-REFERENCE TO RELATED PATENT APPLICATIONS

The present invention claims the benefit of U.S. Provisional Patent Application No. 60/709,321, filed on Aug. 17, 2005, U.S. Provisional Patent Application No. 60/716,395, filed on Sep. 13, 2005, which are all incorporated herein by reference.

### TECHNICAL FIELD OF THE INVENTION

This invention relates generally to a system for measuring the composition, velocity and volumetric flow rate of each phase of a multi-phase mixture (e.g., oil, water, and gas mixture) having entrained gas therein, and more particularly to a system that measures the speed of sound propagating through a flow to determine compositional measurements compensated for entrained gas.

### BACKGROUND OF THE INVENTION

Density meters are commonly used instruments in industrial processes. Common types of density meters include nuclear densitometers, vibrating vane densitometers and Coriolis flow meters which have a density measurement as a by-product measurement. In most applications, density measurements are used to discern bulk properties of a process fluid and are typically intended to provide information about the liquid and solid phases of the process fluid. Unfortunately however, these measurements get confound when an unknown amount of entrained air is present.

For example, consider a two-component mixture. Knowing the component densities and accurately being able to measure the mixture density provides a means to determine the phase fractions of each of the two components. However, the presence of a third phase, such as entrained air (or gas) confounds this relationship. This is because there is typically not a significant contrast in the densities of the liquid components and as such, large errors in phase fraction determination results from small levels of entrained air.

In addition, an accurate measurement of the volumetric flow of the components of a flow is desirable because it can lead to more efficient production. For example, accurate monitoring of the gas void fraction of the flow can lead to improved measurement and production of oil being pump from a reservoir. Unfortunately however, a real time measurement of oil and water mixtures/flows having entrained gas also presents problems in providing an accurate measurement of the volumetric flow of the components of the flow.

Currently, there is an unmet need for multiphase flow measurement in oil and gas production. In fact, the accurate monitoring of well head production rates in the presence of entrained gas has long presented a difficult technical challenge to the oil and gas industry. Performing accurate and timely monitoring of the production rates has many benefits, including the optimization of overall field production and specific well production. The difficulty is due in no small part to the extreme variability of produced fluids which can include various types and mixtures of oil, water, gas, and solid particles.

In response to the above discussed issues, many companies have developed various types of three phase meters that are designed to address the well head flow metering market. However, these products have met relatively limited commercial success due to a combination of performance, accuracy, and cost issues. In light of this, the present invention provides a means and apparatus for well head monitoring that combines multiple existing technologies to meet a wide range of cost and performance goals.

The present invention uses a sonar-based entrained gas measurement to determine the entrained gas level in conjunction with any mixture density measurement to improve the accuracy and therefore value of the density measurement. For example, a sound speed based entrained gas measurement can accurately determine the entrained gas in an aerated mixture without precise knowledge of the composition of either the non-gas components of the multiphase mixture or the composition of the gas itself. Thus, the entrained gas levels can be determined essentially independent of the determination of the liquid properties. Additionally, the accuracy could be improved using the sound speed measurement and mixture density simultaneously, but is not required. Determining the entrained gas level allows for the use of the density measurement to determine the properties of the non-gas component of the multiphase mixture with the same precision as if the gas were not present. This capability also enables the density meter to provide significantly enhanced compositional information for aerated mixtures.

Another difficulty with measuring the composition of the oil/water mixture at the well head involves the pipe not being continuously filled during the pumping processes. In other words, the gas void fraction may randomly vary from 0% to 50%. Unfortunately, current apparatus for measuring the gas void fraction has difficulty or may not be able to accurately measure the gas void fraction of the oil and gas mixture. The present invention provides a continuous real-time measurement of the oil and water mixture having entrained air that temporally varies as the mixture flows through the pipe.

### SUMMARY OF THE INVENTION

An apparatus for determining at least one characteristic of a fluid flowing within a pipe is provided, wherein the pipe is at least one of completely filled and partially filled and wherein the fluid includes a gas component and a liquid component. The apparatus includes a first sensing device for generating first sensor data responsive to a first parameter of the fluid flow, a second sensing device for generating second sensor data responsive to a second parameter of the fluid flow and a processing device communicated with at least one of the first sensing device and the second sensing device to receive the first sensor data and the second sensor data and wherein the processing device processes the first sensor data and the second sensor data to generate flow data responsive to the at least one characteristic of the fluid.

Additionally, a method for determining at least one characteristic of a fluid flowing within a pipe is provided, wherein the fluid includes a gas component and a liquid component. The method includes determining if the gas component is present in a predefined region of the pipe, generating fluid data responsive to whether the gas component is present in the predefined region of the pipe and processing the fluid data to identify the at least one characteristic of the fluid.

### BRIEF DESCRIPTION OF THE DRAWINGS

Referring now to the drawings, the foregoing and other features and advantages of the present invention will be more fully understood from the following detailed description of illustrative embodiments, taken in conjunction with the accompanying drawings in which like elements are numbered alike:

FIG. 1 is a schematic illustration of a flow measuring system for providing a density, composition, velocity and/or volumetric flow rate of the mixture in accordance with the present invention.

FIG. 2 is a schematic illustration of a flow measuring system for providing a density, composition, velocity and/or volumetric flow rate of the mixture wherein the mixture is shown having a temporal variation in the gas void fraction in accordance with the present invention.

FIG. 3a is a block diagram of the processor of the transmitter of the system of FIG. 1 and FIG. 2 to provide a continuous real-time measurement of the mixture in accordance with the present invention.

FIG. 3b is another embodiment of a block diagram of the processor of the transmitter of the system of FIG. 1 and FIG. 2 to provide a continuous real-time measurement of the mixture in accordance with the present invention.

FIG. 3c is a illustrating the error in the oil volume fraction when free gas is present and when the 1−φ_{G} term is ignored.

FIG. 4 is a schematic illustration of another embodiment a flow measuring system for providing a density, composition, velocity and/or volumetric flow rate of the mixture in accordance with the present invention.

FIG. 5 is a block diagram of the processor of the transmitter of the system of FIG. 4 to provide a continuous real-time measurement of the mixture in accordance with the present invention.

FIG. 6 is a schematic illustration of another embodiment a flow measuring system for providing a density, composition, velocity and/or volumetric flow rate of the mixture in accordance with the present invention.

FIG. 7 is a block diagram of the processor of the transmitter of the system of FIG. 6 to provide a continuous real-time measurement of the mixture in accordance with the present invention.

FIG. 8a is a block diagram illustrating one embodiment for measuring the volumetric flow and gas volume fraction of the mixture flowing in the pipe having entrained gas/air therein, in accordance with the present invention.

FIG. 8b is a functional flow diagram of an apparatus embodying the present invention that compensates the volumetric flow measurement of a volumetric flow meter, in accordance with the present invention.

FIG. 9 is a schematic block diagram of a gas void fraction meter, in accordance with the present invention.

FIG. 10 is a schematic block diagram of another embodiment of gas void fraction meter, in accordance with the present invention.

FIG. 11 is a k−ω plot of data processed from an array of pressure sensors use to measure the speed of sound of a fluid flow passing in a pipe, in accordance with the present invention.

FIG. 12 is a schematic block diagram of a volumetric flow meter having an array of sensor, in accordance with the present invention.

FIG. 13 is a graphical cross-sectional view of the fluid flow propagating through a pipe, in accordance with the present invention.

FIG. 14 is a k−ω plot of data processed from an array of pressure sensors use to measure the velocity of a fluid flow passing in a pipe, in accordance with the present invention.

### DETAILED DESCRIPTION OF THE INVENTION

As is known, oil wells tend to produce widely varying amounts of oil, water and gas and thus, exhibit a wide range of multiphase flow patterns. As discussed hereinbefore, this is undesirable due to its negative impact on the measuring devices used to measure the components of a flow. As a result, economical, accurate, real-time measurement of individual well production has remained a long-standing challenge for the oil and gas industry. In order to obtain more accurate measurements, current methods typically involve some form of separation of the produced fluid prior to measurement. For example, producers have historically relied on three phase separators to divide the production streams into single-phase oil, water and gas streams for measurement using conventional, single-phase flow meters. Although generally effective, three phase separators have several undesirable properties that have driven the industry to seek alternative solutions, including size, cost and limited turndown ratios. Recently, advancement of online watercut and gas/liquid separation technology has enabled the industry to consider compact approaches based on two-phase separation. In these systems, the produced stream is separated into a gas and liquid stream for measurement and the net oil is determined by measuring the liquid rate and watercut of the liquid leg.

Although the accuracy of all separation-based measurement approaches is, to some degree, dependent upon separator effectiveness, the accuracy of a net oil measurement from a two-phase separation approach can be particularly sensitive to the presence of a small, but unknown amount of gas in the liquid leg due to its determination of the watercut of the liquid. In fact, from a volumetric flow perspective, the presence of entrained gases in the liquid stream will typically result in an over reporting of the volumetric flow of the liquid that is proportional to the amount of entrained (free) gas in the mixture and for most watercut devices, even a small amount of gas can result in a significant over reporting of oil content, and, in turn, a significant over reporting of net oil production. The sensitivity of the net oil measurement to gas carry-under is a function of the type of watercut monitoring device, as well as the properties of the produced fluids.

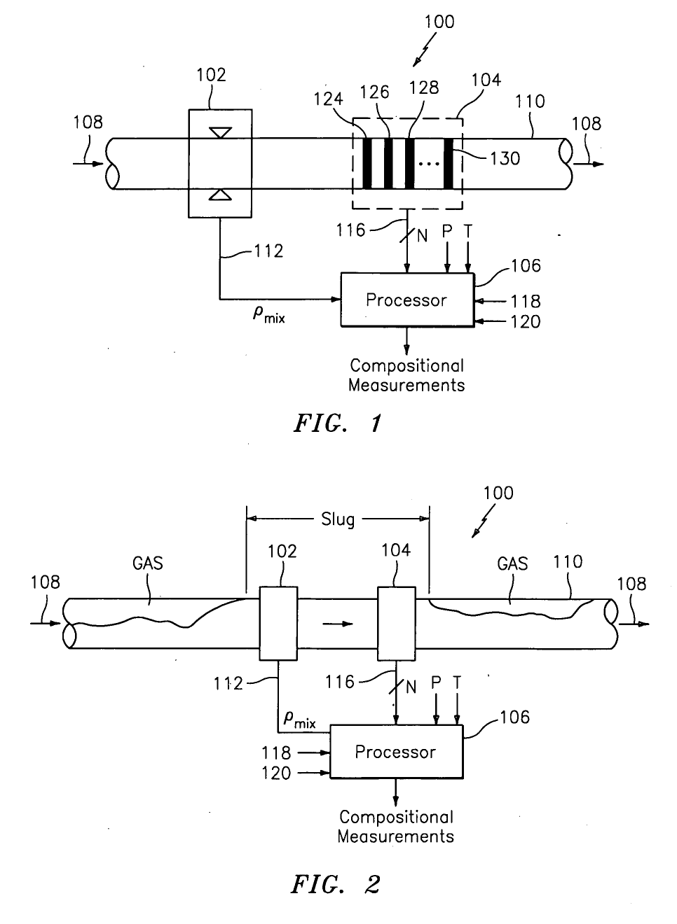

For example using a Coriolis-based density meter to the determine watercut of a mixture with entrained gas present results in the measured mixture density being less than the actual liquid density. Therefore, without knowledge of the presence of the gas, the water cut will be under-reported and net oil rate overstated. Similar inaccuracies will exist in all methods of microwave and nuclear density water cut measurement as well. If, however, the amount of gas in the liquid stream is accurately determined the liquid density can be calculated from the measured mixture density resulting in the proper water cut. Similar calculations can be made with microwave technology measurements. A gas void fraction meter, such as that manufactured by CiDRA Corporation, provides an accurate measurement of gas void fraction in a flowing liquid stream by measuring the propagation speed of naturally occurring low-frequency sound through the liquid/gas mixture, wherein the GVF meter may be used in conjunction with a coriolis or microwave meter to provide the means to accurately measure the water cut in liquid streams independent of gas carry-under, as shown in FIGS. 1, 2, 3a and 3b.

Density meters provide a measurement of the density of a fluid flow or mixture passing through a pipe. As described in detail hereinbefore, a density meter typically provides erroneous density and composition measurements in the presence of entrained gas (e.g., bubbly gas) within the fluid flow. It should be appreciated that the present invention provides composition measurements of a multiphase fluid having entrained gas, wherein the comp measurements include phase fraction of the phase of the mixture, volumetric flow of each phase of mixture, the oil cut, water cut and volumetric flow of mixture.

Moreover, it should be appreciated that one embodiment of the present invention proposes the use of sonar-based entrained gas measurements to determine the entrained gas level in conjunction with any density measurement of a mixture flowing in a pipe to make multiphase compositional measurements of the fluid. A sound speed based entrained gas measurement can accurately determine the amount of entrained gas in an aerated mixture without precise knowledge of the composition of either the non-gas components of the multiphase mixture or the composition of the gas itself. Thus, the entrained gas levels can be determined essentially independent of the determination of the liquid properties and, although not required, the accuracy could be improved by using the sound speed measurement and mixture density simultaneously. It should also be appreciated that determining the entrained gas level enables the density measurement to be used to determine the properties of the non-gas component of the multiphase mixture with the same precision as if the gas was not present. This capability also enables the density meters to provide significantly enhanced compositional information for aerated mixtures.

Referring to FIGS. 1-3b, one embodiment of a flow measuring system 100, in accordance with the present invention, is shown and includes a density meter 102, a sonar meter 104 (wherein the sonar meter 104 can measure the flow rate, the GVF and the SOS propagating through the fluid) and a processing unit 106 to provide any one or more of the following parameters of a fluid flow 108 flowing in a pipe 110, namely, mixture velocity, phase fraction of each phase (e.g., water, oil, and gas), volumetric flow rate of the mixture, and/or volumetric flow rate of each phase and mixture. The fluid flow 108 may be any aerated fluid and/or mixture including liquid, slurries, solid/liquid mixture, liquid/liquid mixture, solid/solid mixture and/or any other multiphase flow having entrained gas and/or water cut and oil cut. It should be appreciated that the sonar meter 104 may be any meter suitable to the desired purpose, such as dual function meter at that disclosed in U.S. patent application Ser. No. 10/875,857, filed Jun. 24, 2004, which is incorporated herein by reference in its entirety.

As will be described in greater detail hereinafter, the density meter 102 in combination with a sonar meter 104 can be used to determine the volumetric flow rates and composition of the mixture 108, namely gas void fraction. The limitation of this embodiment occurs when the gas void fraction is too great. For example, when the gas void fraction exceeds a predetermined value, the sonar meter 104 is unable to determine the gas void fraction. For flows that fill the pipe 110 but that have a gas void fraction that is below a predetermined value, the system 100 is able to determine the composition and volumetric flow parameters in accordance with the method described hereinafter, and also described in U.S. patent application Ser. No. 10/875,857, filed Jun. 24, 2004 and U.S. patent application Ser. No. 10/909,593, filed on Aug. 2, 2004, which are incorporated herein by reference in their entireties.

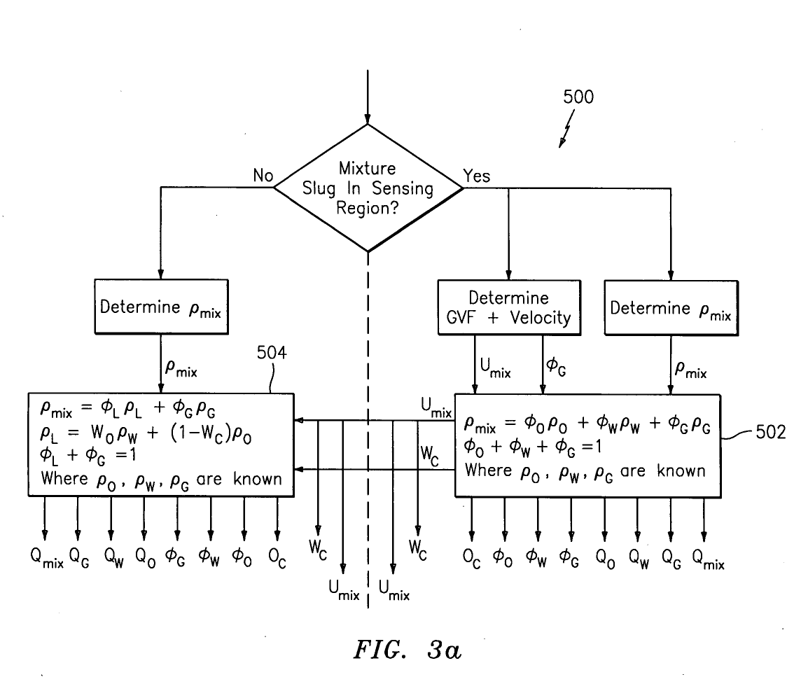

However, the system 100 may work intermittently for mixtures 108 that do not fill the pipe 110 and/or that have a gas void fraction over the predetermined level. Such an inconsistent flow having temporal variations in the levels of the gas void fractions can be found in pipes at well heads, wherein in these instances, the oil, water and gas mixtures 108 flowing from the well (as shown in FIG. 2) through a pipe 110 tend to have random temporal variations of gas void fraction. In these flows, it has also been noticed that periodically slugs of fluid (oil and gas) flow through the pipe 110 for varying periods of time where the pipe 110 is full and has a relatively lower gas void fraction. During this slugging period or window, the conditions are satisfactory for measuring the gas void fraction using the sonar meter 104, provided the period of the slug is at least 6-10 seconds in duration or sufficient time has elapsed for the sonar meter 104 to determine a gas void fraction measurement.

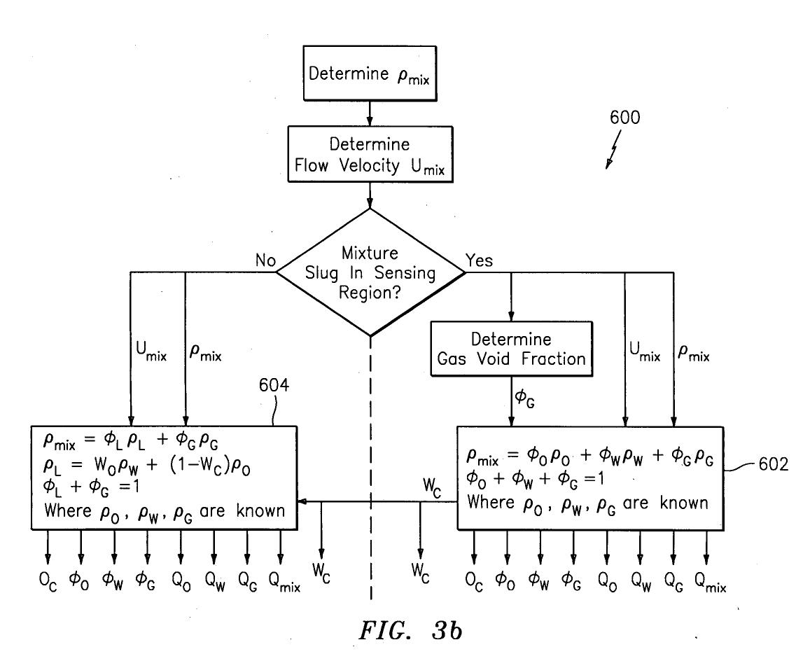

Referring to FIG. 3a, a block diagram 500 illustrating one embodiment of a method for providing a continuous real-time measurement of the mixture 108, in accordance with the present invention is shown. If a slug is in the sensing regions of the meters 102 and 104 for a sufficient time period, the sonar meter 104 is able to measure the gas void fraction (φ_{G}) and the flow velocity (Uₘᵢₓ) of the mixture 108 and the density meter 102 is able to measure the density of the mixture (ρₘᵢₓ) 108. At this point, the density of the oil (ρ_{O}), the density of the water (ρ_{W}), the density of the gas (ρ_{G}), the density of the mixture 108 (ρₘᵢₓ) and the phase fraction of the gas (φ_{G}) is known. However, the phase fraction of the oil (φ_{O}) and the phase fraction of the water (φ_{W}) are still unknown. It is assumed that the water cut will not significantly change between the slugging period and the non-slugging period. As shown in operational block 502 in FIG. 3a, these two unknowns (φₒ, φ_{w}) may be solved to determine the desired parameters using the relationships given by,
ρₘᵢₓ=φ_{O}ρ_{O}+φ_{W}ρ_{W}+φ_{G}ρ_{G}. Eqn. (1)
and
φ_{O}+φ_{W}+φ_{G}=1. Eqn. (2)
where ρₘᵢₓ is the density of the mixture, ρₒ is the density of the oil, ρ_{w} is the density of the water, ρ_{G} is the density of the gas, φₒ is the phase fraction of the oil, φ_{w} is the phase fraction of the water and φ_{G} is the phase fraction of the gas. Additionally, the velocity measured by the sonar meter 104 can be used.

Thus, knowing the velocity of the mixture 108, the cross-section area of the pipe 110, and the phase fractions φₒ, φ_{w}, φ_{G}, the volumetric flow rates Q₀, Q_{w}, Qₒ, Qₘᵢₓ of the mixture 108, the oil cut O_{c}, and the water cut W_{c} may be also determined. As such, it should be appreciated that the water cut W_{C} may be expressed via the relationship given by,

$${W}_{c} = \frac{{Q}_{W}}{{Q}_{O} + {Q}_{W}} , \qquad Eqn . ( 3 )$$

$${ϕ}_{w} = \frac{{A}_{W}}{{A}_{pipe}} , \qquad Eqn . ( 4 )$$

and
Q_{W}=Aₚᵢₚₑφ_{W}Uₘᵢₓ, Eqn. (5)
where Q_{W} is the volumetric flow rate of the water phase and Q_{O} is the volumetric flow rate of the oil phase, A_{W} is the cross sectional area of the water component, Aₚᵢₚₑ is the cross sectional area of the pipe 110 and Uₘᵢₓ is the volumetric flow rate of the mixture. While the equations to determine the water cut (W_{c}) and the volumetric flow of the water (Q_{w}) are shown, similar equations to determine the volumetric flow of the other phase and oil cut may be determined.

Alternatively, when the sensing region does not have a slug, the gas void fraction can not be measured by the sonar meter 104, however the density meter 102 can still measure the density of the mixture. For this period of time, the system 100 can still measure the parameters shown in FIG. 3a to provide a real time continuous measurement of the mixture 108. During this period, the density meter 102 measures the density of the mixture 108 (ρₘᵢₓ). As shown in operational block 504, the velocity of the mixture 108 (Uₘᵢₓ) and the water cut determined during the slug period/window is used to determine the parameters in a similar manner as that shown in operational block 502. At this point the density of the oil (ρ_{O}), the density of the water (ρ_{W}), the density of the gas (ρ_{G}), the density of the mixture 108 (ρₘᵢₓ) and the water cut (Wc) of the mixture 108 is known. However, the phase fraction of the liquid (φ_{L}), the density of the liquid (ρ_{L}) and the phase fraction of the gas (φ_{G}) are still unknown. As shown in operational block 504, these unknowns (φ_{L}, ρ_{L}, ρ_{G}) may be solved to determine the desired parameters using the relationships given by,
ρₘᵢₓ=φ_{L}ρ_{L}+φ_{G}ρ_{G}, Eqn. (6)
ρ_{L}=W_{C}ρ_{W}+(1−W_{C})ρ_{O}, Eqn. (7)
and
φ_{L}+φ_{G}=1. Eqn. (8)

where ρₘᵢₓ is the density of the mixture, ρ_{O} is the density of the oil, ρ_{W} is the density of the water, ρ_{G} is the density of the gas, ρ_{L} is the phase fraction of the liquid, φ_{L} is the phase fraction of the liquid, φ_{G} is the phase fraction of the gas and Wc is the water cut of the mixture. Thus, the volumetric flow rates of the mixture 108 and each phase may now be determined.

It should be appreciated that identifying the relationship between the parameters allows for the determination of desired variables. For example, the density of any N-component mixture equals the sum of the individual component densities times the volumetric fraction and may be given by:

$$ρ = {\sum }_{i = 1}^{N} {ϕ}_{i} {ρ}_{i} , \qquad Eqn . ( 9 )$$

with the constraint that

$${\sum }_{i = 1}^{N} {ϕ}_{i} = 1 ,$$

where ρ is equal to the mixture density, φᵢ is equal to the component volume fraction and ρᵢ is equal to the component density.

As such, for oil, water and gas mixtures the density as given by Eqn. (9) can be expressed as:
ρ=φ_{O}ρ_{O}+φ_{W}ρ_{W}+φ_{G}ρ_{G}, Eqn. (10)
with the constraint that φ_{O}+φ_{W}+φ_{G}=1, where the O, W and G subscripts refer to oil, water and gas, respectively. Combining these equations, assuming φ_{G}ρ_{G} is small and solving for the volume fraction of the oil thus yields:

$${ϕ}_{O} = \frac{ρ - {ρ}_{W} ( 1 - {ϕ}_{G} )}{{ρ}_{O} - {ρ}_{W}} , \qquad Eqn . ( 11 )$$

Again starting with Eqn. (9), but this time assuming the mixture contains only oil and water, the oil fraction (φ′) may be calculated as:

$${ϕ}_{O}^{′} = \frac{ρ - {ρ}_{W}}{{ρ}_{O} - {ρ}_{W}} , \qquad Eqn . ( 12 )$$

It should be appreciated that these equations differ only by the 1−φ_{G} term. Referring to FIG. 3c, a graph illustrating the error in the oil volume fraction (and thus net oil rate) if this term is ignored when free gas is present is shown. It should be appreciated that the errors in the net oil measurement are significant and will result in a gross overstatement of the net oil rate. For example with only a 1% gas void fraction, the error in the oil fraction is between 30 and >100% depending on the oil gravity. Whereas if the free gas is accurately measured and accounted for when calculating the oil fraction, the error is removed. The remaining sections describe a sonar-based method of measuring the free gas and present some experimental and field data demonstrating the measurement concept.

Referring to FIG. 3b, a block diagram 600 illustrating an alternative embodiment of a method for providing a continuous real-time measurement of the mixture 108, in accordance with the present invention is shown. It should be appreciated that the processing unit 106 may process the data provided by the density meter 102 and the sensor array 124-130 to provide the same measurements as described hereinbefore. As shown, the density of the mixture 108 is continually measured by the density meter 102 and the velocity of the mixture 108 is continually measured using the sensor arrays 124-130. When a slug is passing through the sensing region, as described hereinbefore, the sensor array 124-130 measures the gas void fraction (GVF) (φ_{G}) of the mixture 108, wherein the density (ρₘᵢₓ) of the mixture 108 and the flow velocity (Uₘᵢₓ) of the mixture 108 is determined beforehand by any method and/or device suitable to the desired end purpose. It should be appreciated that at this point, the density of the oil (ρ_{O}), the density of the water (ρ_{W}), the density of the gas (ρ_{G}), the density of the mixture 108 (ρₘᵢₓ), the phase fraction of the gas (φ_{G}) and the flow velocity (Uₘᵢₓ) of the mixture 108 is known. However, the phase fraction of the oil (φ_{O}) and the phase fraction of the water (φ_{W}) are still unknown. Now having the two unknown parameters (φ_{G},φ_{W}) and given the relationships as described in Eqn. 1 and Eqn. 2 as shown in operational block 602, the water phase fraction (φ_{W}) (or water cut) and the oil phase fraction (φ_{O}) (or oil cut) can be determined as described in greater detail hereinbefore. Also, as described in greater detail hereinbefore, a number of other parameters of the mixture 108 also may be determined.

In a similar fashion to that described hereinbefore, when a slug is not within the sensing region (as may be defined by the foot print of the sensor array 124-130), the measured density, the measured flow velocity, and the measured GVF (during the slugging period) may be used to determine the parameters of the mixture 108, as shown in operational block 604 and similar to operational block 504 as described hereinbefore.

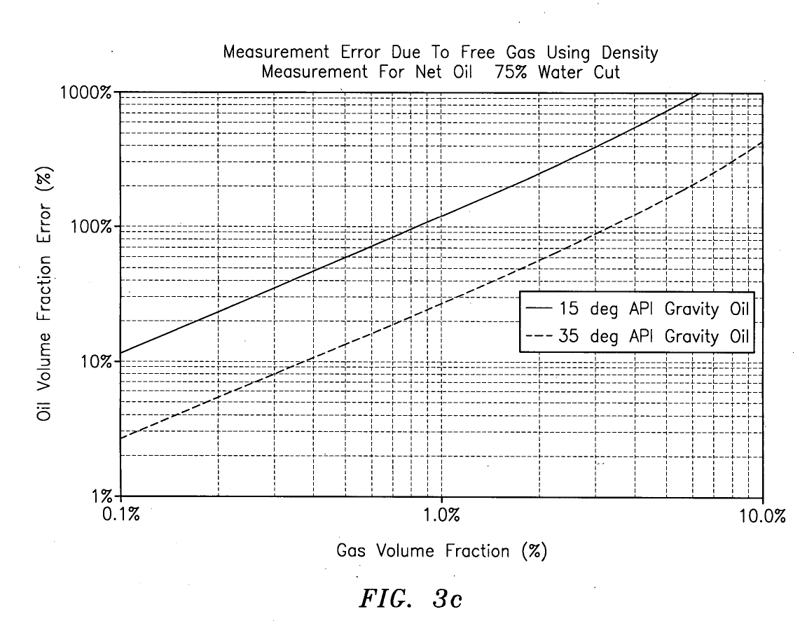

FIG. 4 illustrates another embodiment of the present invention, wherein the sensor array 124-130 includes an ultrasonic sensor 140 for determining the speed of sound propagating through the fluid 108. The ultrasonic sensor 140 comprises a transmitter and receiver for transmitter and receiving an ultrasonic signal propagating through the mixture 108. The time of flight of the signal is used to determine the speed of sound propagating through the liquid.

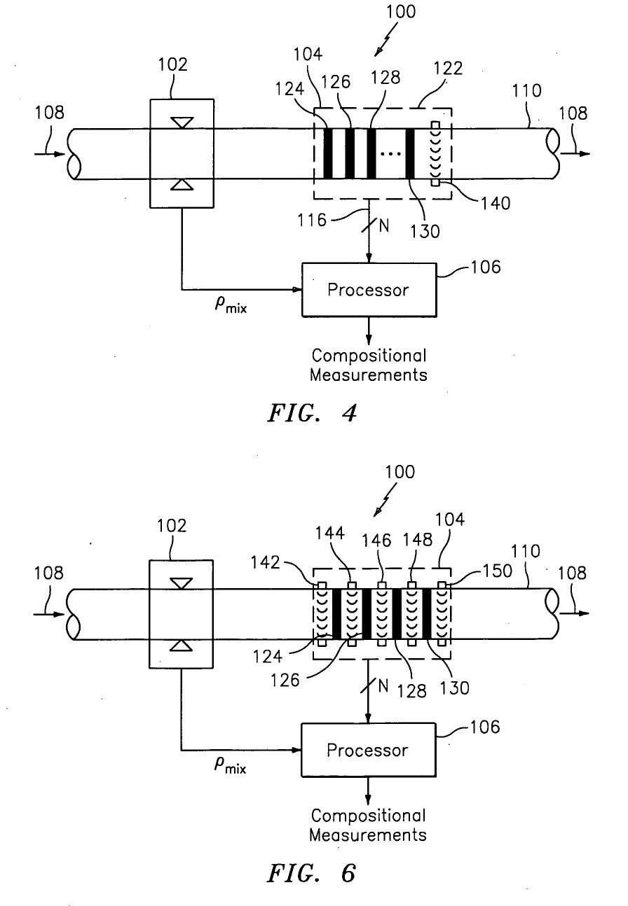

It should also be appreciated that the density meter 102 may continuously measure the density of the mixture (ρₘᵢₓ), the sensor array 124-130 may continually measure the velocity of the mixture (Uₘᵢₓ), and during the slugging period, the ultrasonic sensor 140 may measure the speed of sound propagating through the liquid. Referring to FIG. 5, a block diagram 700 illustrating still yet another alternative embodiment of a method for providing a continuous real-time measurement of the mixture 108, in accordance with the present invention is shown. Knowing the speed of sound of the liquid using the ultrasonic sensor, the water cut may be determined, similar to that described herein and in U.S. patent application Ser. No. 11/442,954 filed on May 30, 2006 and U.S. patent application Ser. No. 10/756,922 filed on Jan. 13, 2004, which is incorporated herein by reference in its entirety. As shown in FIG. 5, the speed of sound of the liquid is measured when a slug is present in the sensing region (as may be defined by the foot print of the ultrasonic sensor). It should be appreciated that the measurement of the speed of sound to determine the water cut using the ultrasonic sensor 140 allows for a faster measurement than that normally provided by a sensor array 124-130 not having an ultrasonic sensor 140, and thus a small slug (one that last for a shorter period of time) is sufficient to provide a water cut measurement, wherein the processing is similar to that described hereinbefore.

If a slug is in the sensing regions of the meters 102 and 104 for a sufficient time period, the water cut (W_{c}) is measured. The water cut (Wc) may then be used with the density (ρₘᵢₓ) of the mixture 108 and the flow velocity (Uₘᵢₓ) of the mixture 108, which are determined beforehand by any method and/or device suitable to the desired end purpose, to determine the desired parameters. At this point, although the density of the water (ρ_{W}), the density of the gas (ρ_{G}), the density of the mixture 108 (ρₘᵢₓ), the flow velocity (Uₘᵢₓ) of the mixture 108, the density of the oil (ρ_{O}) and the water cut is known, the phase fraction of the liquid (φ_{L}), the density of the liquid (ρ_{L}) and the phase fraction of the gas (φ_{G}) are still unknown. As shown in operational block 702 in FIG. 5, these three unknowns (φ_{L},φ_{G}, ρ_{L}) may be solved to determine the desired parameters using the relationships given by,
ρₘᵢₓ=φ_{L}ρ_{L}+φ_{G}ρ_{G}, Eqn. (13)
ρ_{L}=W_{C}ρ_{W}+(1−W_{C})ρ_{O}, Eqn. (14)
and
φ_{L}+φ_{G}=1. Eqn. (15)

where ρₘᵢₓ is the density of the mixture, ρ_{G} is the density of the gas, ρ_{L} is the density of the liquid, ρ_{L} is the phase fraction of the liquid, Wc is the water cut, ρ_{O} is the phase fraction of the oil and φ_{G} is the phase fraction of the gas. This allows for the determination of the water cut (Wc), the oil cut (Oc), the phase fraction of the water (φ_{W}), the phase fraction of the oil (φ_{O}), the phase fraction of the gas (φ_{G}), the volumetric flow rate of the water (Q_{W}), the volumetric flow rate of the oil (Q_{O}), the volumetric flow rate of the gas (Q_{G}) and the volumetric flow rate of the mixture (Qₘᵢₓ), as described hereinbefore. Alternatively as shown in operational block 704, when the pipe 110 is not full (or slugging), the parameters may still be determined using the measured density (ρₘᵢₓ) of the mixture 108, the measured velocity (Uₘᵢₓ) of the mixture 108 and the water cut (Wc) measured during the slugging period, as similarly described hereinbefore.

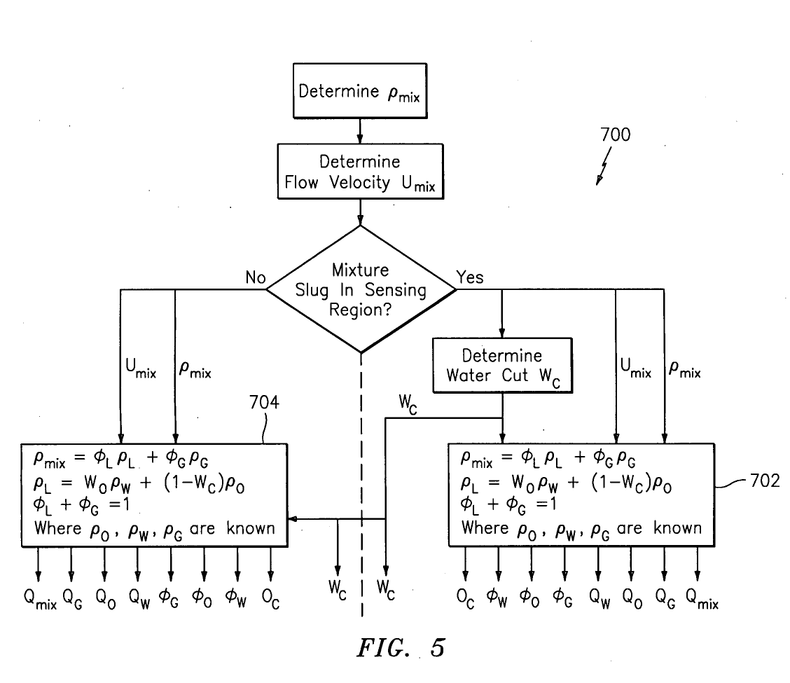

FIG. 6 illustrates another embodiment of the present invention and includes both an array of strain sensors 124-130 and an array of ultrasonic sensors 142-148. As shown, the array of strain sensors 124-130 and array of ultrasonic sensors 142-148 are interlaced such that a strain sensor and ultrasonic sensor are alternately disposed axially along the pipe 110. While shown interlaced, one skilled in the art will appreciate that the strain sensor array 124-130 and the ultrasonic sensor array 142-148 may be disposed axially adjacent to each other, and not interlaced, similar to that shown in U.S. patent application Ser. No. 10/964,043 filed on Oct. 12, 2004, which is incorporated herein by reference in its entirety. The array of ultrasonic sensors 142-148 provide a second means for measuring the velocity of the fluid mixture (Uₘᵢₓ). In addition, an extra ultrasonic sensor (e.g., 150) may be used to determine the speed of sound propagating through the liquid (and hence the water cut) or one of the ultrasonic sensors used to measure velocity may also be used to measure the speed of sound propagating through the liquid.

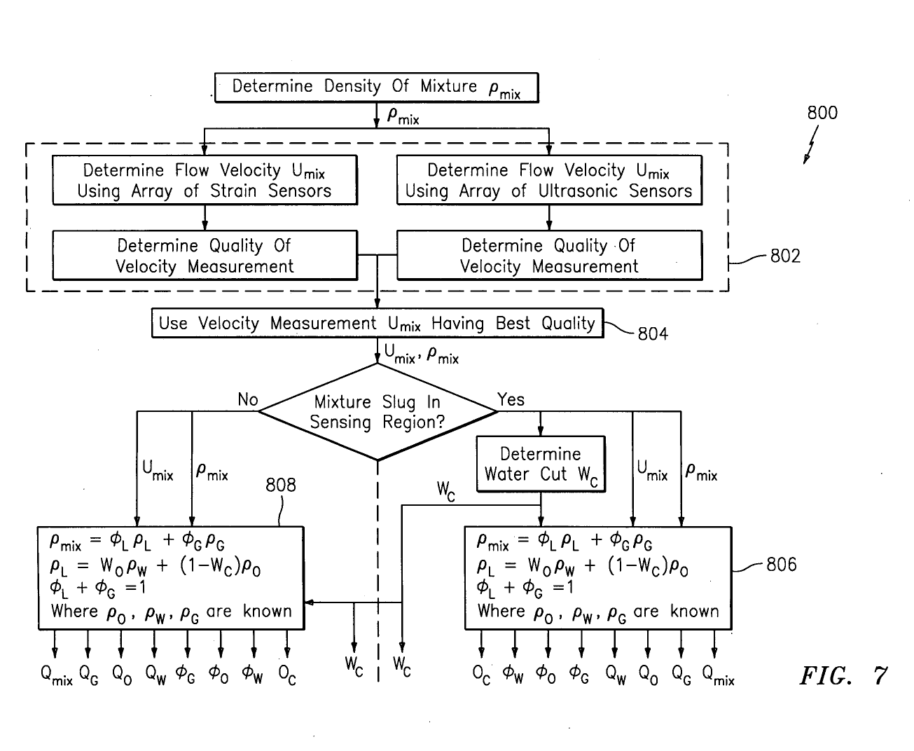

As shown in FIG. 7, it should be further appreciated that although the processing unit 106 may process the data from the strain sensors and ultrasonic sensors in a similar method as that shown in FIG. 4 and FIG. 5, the array of ultrasonic sensors 142-148 may also provide a second means of measuring the velocity of the mixture 108. Referring to FIG. 7, a block diagram 800 illustrating still yet another alternative embodiment of a method for providing a continuous real-time measurement of the mixture 108, in accordance with the present invention is shown. As shown, both sensor arrays provide continuous output of the velocity of the mixture 108 in the pipe 110. The processing unit 106 continually evaluates the quality of each of the velocity measurements, as shown in operational block series 802 and similar to that described in U.S. patent application Ser. No. 11/011,453 filed on Dec. 12, 2004, which is incorporated herein by reference in its entirety.

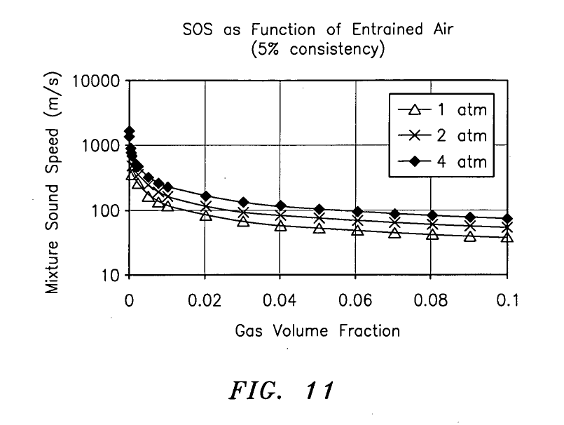

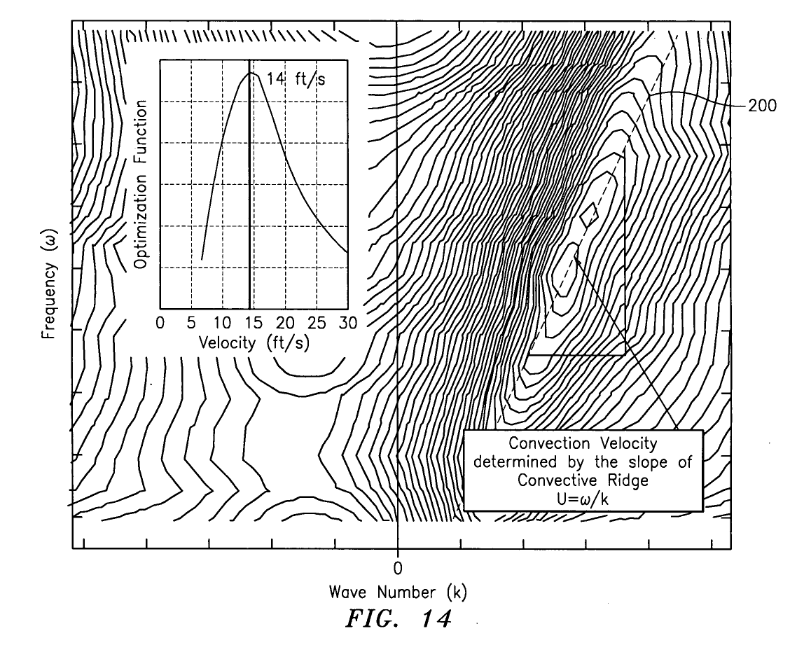

Referring to FIG. 11 and FIG. 14, it should be appreciated that the quality of the measurement of the flow velocity of the mixture 108 may be determined via a quality metric, which may be generated by comparing an accumulated energy (power) of k−ω pairs along the ridge with an accumulated energy (power) of k−ω pairs along at least one ray extending in the k−ω plot. In other words, the quality metric is determined by comparing the accumulated energy at the best velocity (P_{best velocity}) to a reference accumulated energy (P_{reference}), which is determined as a function of one or more trial velocities. For example, P_{reference} may be an average of accumulated energies for a range of trial velocities. Alternatively, P_{reference} may be determined as a function of a single trial velocity (a reference velocity). The reference velocity may be a predetermined velocity, such as the maximum or minimum velocity, or may be determined as a function of the best velocity (e.g., 75% of the best velocity, 50% of the best velocity, etc.).

In one embodiment, the reference velocity is selected by determining the accumulated energy for a plurality of different velocities and selecting the reference velocity as that velocity providing the maximum accumulated energy. For example, the quality metric algorithm may use a reference velocity determined from the maximum of one of the following four values: 1) accumulated energy at 75% of best velocity, 2) accumulated energy at 125% of best velocity, 3) accumulated energy at minimum velocity and 4) accumulated energy at maximum velocity, although it is not necessarily limited to these. However, while the quality metric description herein references four points for determining the accumulated energy of the reference velocity, the invention contemplates that any number of points or point locations may be used.

After the accumulated energy at the best velocity (P_{best velocity}) and reference accumulated energy (P_{reference}) are determined, they are then converted from the dB scale to a linear scale [10ˆ(dB/10)=linear output]. The quality metric may then be calculated by dividing the difference of P_{best velocity} and P_{reference} by the sum of P_{best velocity} and P_{reference}, as shown by the following equation,

$$Q = \frac{{P}_{Best Velocity} - {P}_{Reference}}{{P}_{Best Velocity} + {P}_{Reference}} . \qquad Eqn . ( 16 )$$

If P_{best velocity} is much bigger than P_{reference}, indicating a sharp, unique convective ridge resulting from a high signal to noise ratio and proper operation of the sonar meter 104, the quality metric will approach one. Conversely, if P_{best velocity} and P_{reference} are equal, indicating an indistinct convective ridge resulting from a low signal to noise ratio or improper operation of the sonar meter 104, the quality metric will equal zero. Therefore, the processor can evaluate the quality of the convective ridge using the quality metric. If the quality metric is below a predetermined threshold, the sonar meter 104 will provide an error. For example, a threshold of about 0.2 may be used, but this threshold may vary depending upon the environment in which the sensor array 124-130 is located. On the other hand, if the quality metric is greater than or equal to the threshold, there is a level of confidence the sonar meter 104 is operating properly and the fluid velocity may be determined using the slope of the convective ridge (FIG. 14). In this case, the analyzer 198 examines the convective ridge information including the convective ridge orientation (slope). Assuming the straight-line dispersion relation given by k=ω/u, the analyzer 198 determines the flow velocity, Mach number and/or volumetric flow, which are output as parameters. The volumetric flow is determined by multiplying the cross-sectional area of the inside of the pipe 110 with the velocity of the process flow 108.

In a similar fashion, referring to FIG. 11, after at least one of the acoustic ridges 178, 180 is identified in the k−ω plot, the quality of the at least one ridge 178, 180 can be determined using the method as described in more detail hereinabove. As above, the quality of the measurement is determined by comparing the accumulated energy at the best velocity (P_{best velocity}) to a reference accumulated energy (P_{reference}), which is determined as a function of one or more trial velocities. For example, P_{reference} may be an average of accumulated energies for a range of trial velocities or for corresponding trial velocities in the right and left planes of the k−ω plot. Alternatively, P_{reference} may be determined as a function of a single trial velocity (a reference velocity). The reference velocity may be a predetermined velocity, such as the maximum or minimum velocity, or may be determined as a function of the best velocity (e.g., 75% of the best velocity, 50% of the best velocity, etc.).

In one embodiment, the reference velocity is selected by determining the accumulated energy for a plurality of different velocities and selecting the reference velocity as that velocity providing the maximum accumulated energy. For example, the quality metric algorithm may use a reference velocity determined from the maximum of one of the following four values: 1) accumulated energy at 75% of best velocity, 2) accumulated energy at 125% of best velocity, 3) accumulated energy at minimum velocity and 4) accumulated energy at maximum velocity, although it is not necessarily limited to these.

Some or all of the functions within the flow logic 100 may be implemented in software (using a microprocessor or computer) and/or firmware, or may be implemented using analog and/or digital hardware, having sufficient memory, interfaces, and capacity to perform the functions described herein.

The velocity having the better quality metric may then be used in the determination of the parameters of the fluid, as shown in operational block 804. This may be accomplished in a similar manner as that described in greater detail hereinbefore for FIG. 5, wherein if a measurement is taken while the mixture 108 is ‘slugging’ the desired parameters may be determined as that shown in operational block 806 and wherein if the mixture 108 is not ‘slugging’, then the desired parameters may be determined as that shown in operational block 808.

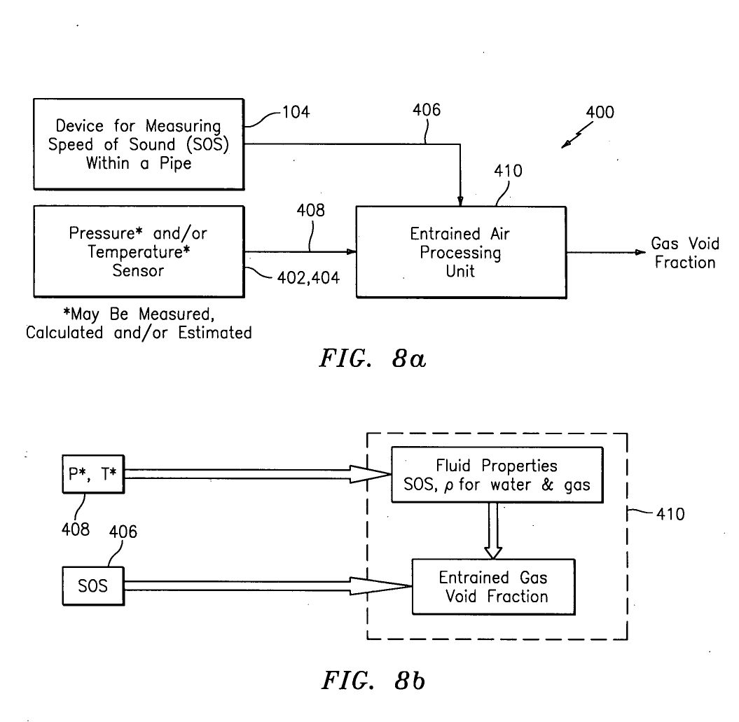

FIG. 8a is a block diagram 400 of one embodiment of the apparatus 100 of the present invention and includes a sonar meter 104 for measuring the speed of sound (SOS) propagating through the flow 108 within a pipe 110. A pressure sensor and/or temperature sensor 402, 404 may measure the pressure and/or temperature, respective, of the mixture 108 flowing through the pipe 110. In response to the speed of sound signal 406 and the characteristics 408 of the flow 108 (e.g., pressure and temperature), an entrained gas processing unit 410 determines the gas void fraction (GVF) of the flow 108. The pressure and temperature sensors 402, 404 enables the apparatus 100 to compensate or determine the gas volume fraction for dynamic changes in the pressure and temperature of the flow 108. Alternatively, the pressure and/or temperature may be estimated rather than actually measured.

A flow chart 412 shown in FIG. 8b illustrates the function of the entrained gas processing unit 410. As shown in FIG. 8a, the inputs to the processing unit 410 include the speed of sound (SOS) 406 within the mixture 108 in the pipe 110, and the pressure and/or temperature of the mixture 108. The fluid properties of the mixture 108 (e.g., SOS and density) are determined knowing the pressure and temperature of the mixture 108. The gas void fraction of the mixture 108 (GVF) is determined using the SOS measurement and fluid properties, which are described in greater detail herein.

Other information relating to the gas void fraction in a fluid and the speed of sound (or sonic velocity) in the fluid, is described in “Fluid Mechanics and Measurements in two-phase flow Systems”, Institution of mechanical engineers, proceedings 1969-1970 Vol. 184 part 3C, Sep. 24-25 1969, Birdcage Walk, Westminster, London S.W. 1, England, which is incorporated herein by reference in its entirety.

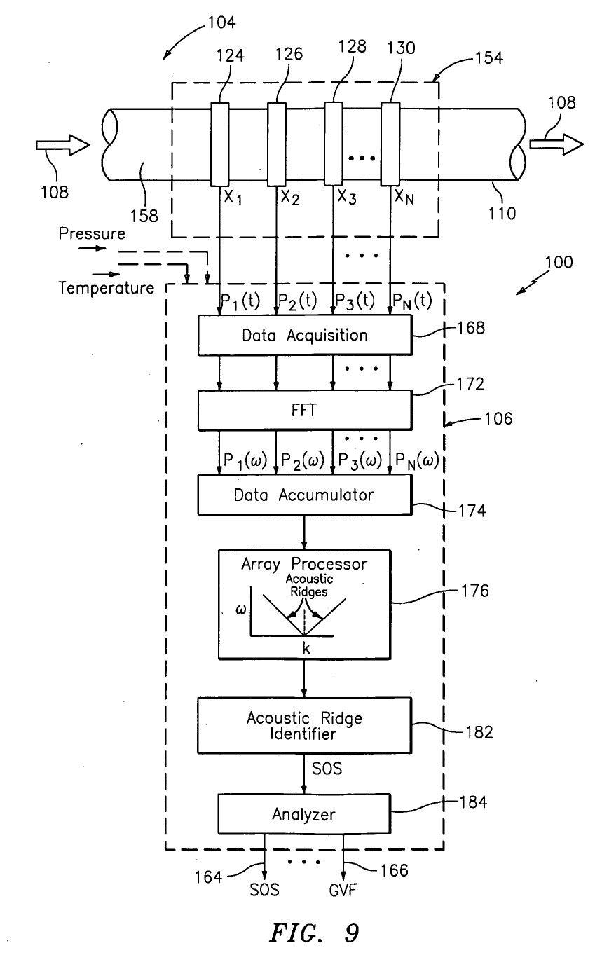

FIG. 9 illustrates the sonar meter 104 of FIG. 2, as described hereinbefore. The sonar meter 104 includes a sensing device 154 disposed on the pipe 110 and a processing unit 106. The sensing device 154 comprises an array of strain-based sensors or pressure sensors 124-130 for measuring the unsteady pressures produced by acoustic waves propagating through the flow 108 to determine the speed of sound (SOS). The pressure signals P₁(t)-P_{N}(t) are provided to the processing unit 106, which digitizes the pressure signals and computes the SOS and GVF parameters. A cable electronically connects the sensing device 154 to the processing unit 106. The analog pressure sensor signals P₁(t)-P_{N}(t) are typically 4-20 mA current loop signals.

The array of pressure sensors 124-130 comprises an array of at least two pressure sensors 124,126 spaced axially along the outer surface 158 of the pipe 110, having a process flow 108 propagating therein. The pressure sensors 124-130 may be clamped onto or generally removably mounted to the pipe 110 by any releasable fastener, such as bolts, screws and clamps. Alternatively, the sensors may be permanently attached to, ported in or integral (e.g., embedded) with the pipe 110. The array of sensors of the sensing device 154 may include any number of pressure sensors 124-130 greater than two sensors, such as three, four, eight, sixteen or N number of sensors between two and twenty-four sensors. Generally, the accuracy of the measurement improves as the number of sensors in the array increases. The degree of accuracy provided by the greater number of sensors is offset by the increase in complexity and time for computing the desired output parameter of the flow. Therefore, the number of sensors used is dependent at least on the degree of accuracy desired and the desire update rate of the output parameter provided by the apparatus 100. The pressure sensors 124-130 measure the unsteady pressures produced by acoustic waves propagating through the flow 108, which are indicative of the SOS propagating through the fluid flow 108 in the pipe 110. The output signals (P₁(t)-P_{N}(t)) of the pressure sensors 124-130 are provided to a pre-amplifier unit that amplifies the signals generated by the pressure sensors 124-130. The processing unit 106 processes the pressure measurement data P₁(t)-P_{N}(t) and determines the desired parameters and characteristics of the flow 108, as described hereinbefore. Although the sensing device 154 is shown as being comprised of an array of pressure sensors 124-130, it should be appreciated that the sensing device 154 may also include ultrasonic sensors, individual or in an array fashion and/or a combination of ultrasonic sensors and pressure sensors, in both individual and array fashion.

The apparatus 100 also contemplates providing one or more acoustic sources to enable the measurement of the speed of sound propagating through the flow 108 for instances of acoustically quiet flow. The acoustic source may be a device the taps or vibrates on the wall of the pipe 110, for example. The acoustic sources may be disposed at the input end of output end of the array of sensors 124-130, or at both ends as shown. One should appreciate that in most instances the acoustics sources are not necessary and the apparatus passively detects the acoustic ridge provided in the flow 108, as will be described in greater detail hereinafter. The passive noise includes noise generated by pumps, valves, motors, and the turbulent mixture itself.

As suggested and further described in greater detail hereinafter, the apparatus 100 has the ability to measure the speed of sound (SOS) by measuring unsteady pressures created by acoustical disturbances propagating through the flow 108. Knowing or estimating the pressure and/or temperature of the flow and the speed of sound of the acoustic disturbances or waves, the processing unit 106 can determine gas void fraction, such as that described in U.S. patent application Ser. No. 10/349,716 (CiDRA Docket No. CC-0579), filed Jan. 23, 2003, U.S. patent application Ser. No. 10/376,427 (CiDRA Docket No. CC-0596), filed Feb. 26, 2003, U.S. patent application Ser. No. 10/762,410 (CiDRA Docket No. CC-0703), filed Jan. 21, 2004, which are all incorporated by reference in their entireties.

The sonar meter 104 of FIG. 1 embodying the present invention has an array of at least two pressure sensors 124,126, located at two locations x₁,x₂ axially along the pipe 110 for sensing respective stochastic signals propagating between the sensors 124,126 within the pipe at their respective locations. Each sensor 124,126 provides a signal indicating an unsteady pressure at the location of each sensor, at each instant in a series of sampling instants. One will appreciate that the sensor array 124-130 may include more than two pressure sensors as depicted by pressure sensor 124,126 at location x₃,x_{N}. The pressure generated by the acoustic pressure disturbances may be measured through strained-based sensors and/or pressure sensors 124-130. The pressure sensors 124-130 provide analog pressure time-varying signals P₁(t),P₂(t),P₃(t),P_{N}(t) to the signal processing unit 106. The processing unit 106 processes the pressure signals to first provide output signals 164, 166 indicative of the speed of sound propagating through the flow 108, and subsequently, provide a GVF measurement in response to pressure disturbances generated by acoustic waves propagating through the flow 108.

The processing unit 106 receives the pressure signals from the array of sensors 124-130. A data acquisition unit 168 digitizes pressure signals P₁(t)-P_{N}(t) associated with the acoustic waves propagating through the pipe 110. An FFT logic 172 calculates the Fourier transform of the digitized time-based input signals P₁(t)-P_{N}(t) and provide complex frequency domain (or frequency based) signals P₁(ω),P₂(ω),P₃(ω),P_{N}(ω) indicative of the frequency content of the input signals.

A data accumulator 174 accumulates the additional signals P₁(t)-P_{N}(t) from the sensors, and provides the data accumulated over a sampling interval to an array processor 176, which performs a spatial-temporal (two-dimensional) transform of the sensor data, from the x−t domain to the k−ω domain, and then calculates the power in the k−ω plane, as represented by a k−ω plot, similar to that provided by the convective array processor 194 as discussed in further detail hereinafter.

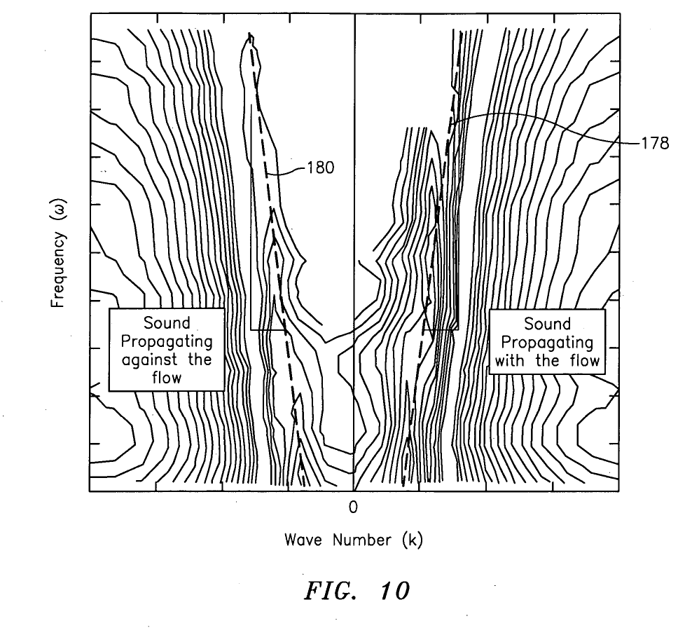

To calculate the power in the k−ω plane, as represented by a k−ω plot (see FIG. 10) of either the signals or the differenced signals, the array processor 176 determines the wavelength and so the (spatial) wavenumber k, and also the (temporal) frequency and so the angular frequency ω, of various of the spectral components of the stochastic parameter. It should be appreciated that there are numerous algorithms available in the public domain to perform the spatial/temporal decomposition of arrays of sensor units 124-130 and any of those may be used suitable to the desired end purpose.

In the case of suitable acoustic waves being present in both axial directions, the power in the k−ω plane shown in a k−ω plot of FIG. 10 so determined will exhibit a structure that is called an acoustic ridge 178,180 in both the left and right planes of the plot, wherein one of the acoustic ridges 178 is indicative of the speed of sound traveling in one axial direction and the other acoustic ridge 180 being indicative of the speed of sound traveling in the other axial direction. The acoustic ridges 178,180 represent the concentration of a stochastic parameter that propagates through the flow 108 and is a mathematical manifestation of the relationship between the spatial variations and temporal variations described above. Such a plot will indicate a tendency for k−ω pairs to appear more or less along a line 178,180 with some slope, wherein the slope indicates the speed of sound.

The power in the k−ω plane so determined is then provided to an acoustic ridge identifier 182, which uses one or another feature extraction method to determine the location and orientation (slope) of any acoustic ridge present in the left and right k−ω plane. The velocity may be determined by using the slope of one of the two acoustic ridges 178,180 or by averaging the slopes of the acoustic ridges 178,180.

Finally, information including the acoustic ridge orientation (slope) is used by an analyzer 184 to determine the flow parameters relating to measured speed of sound, such as the consistency or composition of the flow, the density of the flow, the average size of particles in the flow, the air/mass ratio of the flow, gas void fraction of the flow, the speed of sound propagating through the flow, and/or the percentage of entrained air within the flow 108.

The array processor 176 uses standard so-called beam forming, array processing, or adaptive array-processing algorithms, i.e. algorithms for processing the sensor signals using various delays and weighting to create suitable phase relationships between the signals provided by the different sensors, thereby creating phased antenna array functionality. In other words, the beam forming or array processing algorithms transform the time domain signals from the sensor array into their spatial and temporal frequency components, i.e. into a set of wave numbers given by k=2π/λ where λ is the wavelength of a spectral component, and corresponding angular frequencies given by ω=2πσ.

One such technique of determining the speed of sound propagating through the flow 108 is using array processing techniques to define an acoustic ridge 178,180 in the k−ω plane as shown in FIG. 10. The slope of the acoustic ridge 178,180 is indicative of the speed of sound propagating through the flow 108. The speed of sound (SOS) is determined by applying sonar arraying processing techniques to determine the speed at which the one dimensional acoustic waves propagate past the axial array of unsteady pressure measurements distributed along the pipe 110.

The apparatus 100 of the present invention measures the speed of sound (SOS) of one-dimensional sound waves propagating through the mixture 108 to determine the gas void fraction of the mixture 108. It is known that sound propagates through various mediums at various speeds in such fields as SONAR and RADAR fields. The speed of sound propagating through the pipe and flow 12 may be determined using a number of known techniques, such as those set forth in U.S. patent application Ser. No. 09/344,094, filed Jun. 25, 1999, now U.S. Pat. No. 6,354,147; U.S. patent application Ser. No. 10/795,111, filed Mar. 4, 2004; U.S. patent application Ser. No. 09/997,221, filed Nov. 28, 2001, now U.S. Pat. No. 6,587,798; U.S. patent application Ser. No. 10/007,749, filed Nov. 7, 2001, and U.S. patent application Ser. No. 10/762,410, filed Jan. 21, 2004, each of which are incorporated herein by reference in their entireties.

While the sonar-based flow meter using an array of sensors 124-130 to measure the speed of sound of an acoustic wave propagating through the mixture 108 is shown and described, one will appreciate that any means for measuring the speed of sound of the acoustic wave may used to determine the entrained gas void fraction of the mixture/fluid or other characteristics of the flow described hereinbefore.

The analyzer 184 of the processing unit 106 provides output signals indicative of characteristics of the process flow 108 that are related to the measured speed of sound (SOS) propagating through the flow 108. For example, to determine the gas void fraction (or phase fraction), the analyzer 184 assumes a nearly isothermal condition for the flow 108. As such the gas void fraction or the void fraction is related to the speed of sound by the following quadratic equation:
Ax²+Bx+C=0, Eqn. (17)
wherein x is the speed of sound, A=1+rg/rl*(K_{eff}/P−1)−K_{eff}/P, B=K_{eff}/P−2+rg/rl; C=1−K_{eff}/rl*aₘₑₐₛˆ2); Rg=gas density, rl=liquid density, K_{eff}=effective K (modulus of the liquid and pipewall), P=pressure, and aₘₑₐₛ=measured speed of sound. Effectively, the Gas void fraction may be given by:
GVF=(−B+sqrt(Bˆ2−4*A*C))/(2*A), Eqn. (18)

Alternatively, the sound speed of a mixture can be related to volumetric phase fraction (φᵢ) of the components and the sound speed (a) and densities (ρ) of the component through the Wood equation,

$$\frac{1}{{ρ}_{mix} {a}_{{mix}_{∞}}^{2}} = {\sum }_{i = 1}^{N} \frac{{ϕ}_{i}}{{ρ}_{i} {a}_{i}^{2}} , \qquad Eqn . ( 19 )$$

where,

$${ρ}_{mix} = {\sum }_{i = 1}^{N} {ρ}_{i} {ϕ}_{i} . \qquad Eqn . ( 20 )$$

One dimensional compression waves propagating within a flow 108 contained within a pipe 110 exert an unsteady internal pressure loading on the pipe 110. The degree to which the pipe 110 displaces as a result of the unsteady pressure loading influences the speed of propagation of the compression wave. The relationship among the infinite domain speed of sound and density of a mixture; the elastic modulus (E), thickness (t), and radius (R) of a vacuum-backed cylindrical conduit; and the effective propagation velocity (a_{eff}) for one dimensional compression is given by the following expression:

$${a}_{eff} = \frac{1}{\sqrt{\frac{1}{{a}_{{mix}_{∞}}^{2}} + {ρ}_{mix} \frac{2 R}{Et}}} . \qquad Eqn . ( 21 )$$

The mixing rule essentially states that the compressibility of a mixture (1/(ρ a²)) is the volumetrically-weighted average of the compressibilities of the components. For gas/liquid mixtures at pressure and temperatures typical of the paper and pulp industry, the compressibility of gas phase is orders of magnitudes greater than that of the liquid phase. Thus, the compressibility of the gas phase and the density of the liquid phase primarily determine mixture sound speed, and as such, it is necessary to have a good estimate of process pressure to interpret mixture sound speed in terms of volumetric fraction of entrained gas. The effect of process pressure on the relationship between sound speed and entrained air volume fraction is shown in FIG. 11.

It should be appreciated that some or all of the functions within the processing unit 106 may be implemented in software (using a microprocessor or computer) and/or firmware, or may be implemented using analog and/or digital hardware, having sufficient memory, interfaces, and capacity to perform the functions described herein. Moreover, while the embodiments of the present invention disclosed herein show the pressure sensors 124-130 disposed on the pipe 110, separate from the density meter 102, the present invention contemplates that the sonar meter 104 may be integrated with the density meter 102 to thereby provide a single apparatus. In this integrated embodiment, the pressure sensors 124-130 may be disposed on one or both of the tubes of the density meter 102.

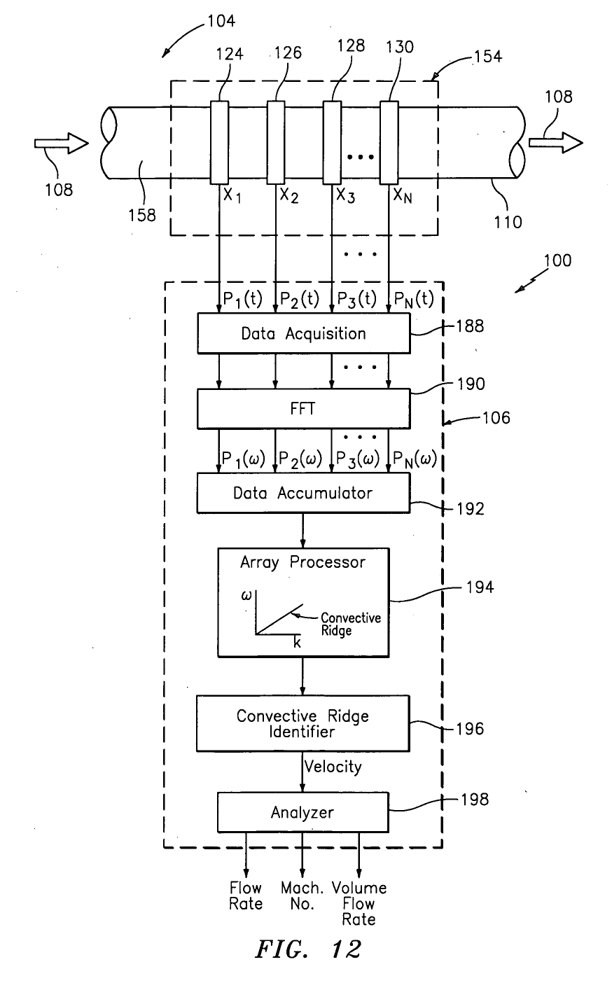

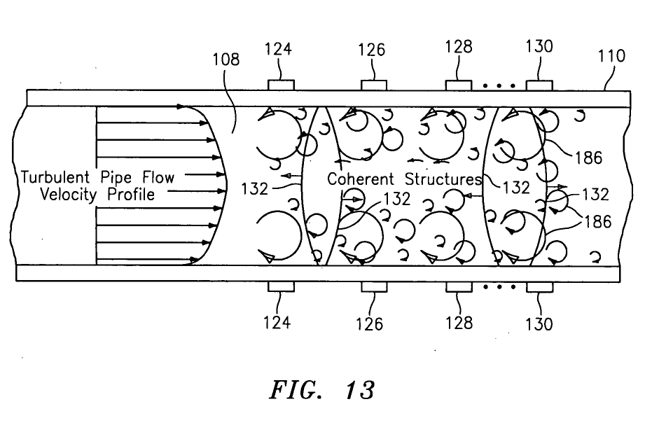

As shown in FIG. 12 and FIG. 13, the sonar meter 104 may process the array of pressure signals to determine the velocity and/or the volumetric flow of fluid flow 108. The sonar meter 104 embodying the present invention has an array of at least two pressure sensors 124,126 located at two locations x₁,x₂ axially along the pipe 110 for sensing respective stochastic signals propagating between the sensors 124,126 within the pipe 110 at their respective locations. Each sensor 124,126 provides a signal indicating an unsteady pressure at the location of each sensor 124,126 at each instant in a series of sampling instants. One will appreciate that the sensor array 124-130 may include more than two pressure sensors as depicted by pressure sensor 128,130 at location x₃,x_{N}. The pressure generated by the convective pressure disturbances (e.g., eddies 186, see FIG. 13) may be measured through strained-based sensors and/or pressure sensors 124-130. The pressure sensors 124-130 provide analog pressure time-varying signals P₁(t),P₂(t),P₃(t),P_{N}(t) to the signal processing unit 106. The processing unit 106 processes the pressure signals to first provide output signals indicative of the pressure disturbances that convect with the flow 108, and subsequently, provide output signals in response to pressure disturbances generated by convective waves propagating through the flow 108, such as velocity, Mach number and volumetric flow rate of the process flow 108.

The processing unit 106 receives the pressure signals from the array of sensors 124-130. A data acquisition unit 188 (e.g., A/D converter) converts the analog signals to respective digital signals. The FFT logic 190 calculates the Fourier transform of the digitized time-based input signals P₁(t)-P_{N}(t) and provides complex frequency domain (or frequency based) signals P₁(ω),P₂(ω),P₃(ω),P_{N}(ω) indicative of the frequency content of the input signals. Instead of FFT's, any other technique for obtaining the frequency domain characteristics of the signals P₁(t)-P_{N}(t), may be used. For example, the cross-spectral density and the power spectral density may be used to form a frequency domain transfer functions (or frequency response or ratios) discussed hereinafter.

One technique of determining the convection velocity of the turbulent eddies 186 within the process flow 108 is by characterizing a convective ridge of the resulting unsteady pressures using an array of sensors or other beam forming techniques, similar to that described in U.S. patent application Ser. No. (Cidra's Docket No. CC-0122A) and U.S. patent application Ser. No. 09/729,994 (Cidra's Docket No. CC-0297), filed Dec. 4, 200, now U.S. Pat. No. 6,609,069, which are incorporated herein by reference in their entireties.

A data accumulator 192 accumulates the frequency signals P₁(ω)-P_{N}(ω) over a sampling interval, and provides the data to an array processor 194, which performs a spatial-temporal (two-dimensional) transform of the sensor data, from the xt domain to the k−ω domain, and then calculates the power in the k−ω plane, as represented by a k−ω plot (See FIG. 14).

The array processor 194 uses standard so-called beam forming, array processing, or adaptive array-processing algorithms, i.e. algorithms for processing the sensor signals using various delays and weighting to create suitable phase relationships between the signals provided by the different sensors, thereby creating phased antenna array functionality. In other words, the beam forming or array processing algorithms transform the time domain signals from the sensor array into their spatial and temporal frequency components, i.e. into a set of wave numbers given by k=2π/λ where λ is the wavelength of a spectral component, and corresponding angular frequencies given by ω=2πσ.

It should be appreciated that the prior art teaches many algorithms of use in spatially and temporally decomposing a signal from a phased array of sensors, and the present invention is not restricted to any particular algorithm. One particular adaptive array processing algorithm is the Capon method/algorithm. While the Capon method is described as one method, the present invention contemplates the use of other adaptive array processing algorithms, such as MUSIC algorithm. The present invention recognizes that such techniques can be used to determine flow rate, i.e. that the signals caused by a stochastic parameter convecting with a flow are time stationary and have a coherence length long enough that it is practical to locate sensor units apart from each other and yet still be within the coherence length.

Convective characteristics or parameters have a dispersion relationship that can be approximated by the straight-line equation,
k=ω/u, Eqn. (22)
where u is the convection velocity (flow velocity). A plot of k−ω pairs obtained from a spectral analysis of sensor samples associated with convective parameters portrayed so that the energy of the disturbance spectrally corresponding to pairings that might be described as a substantially straight ridge, a ridge that in turbulent boundary layer theory is called a convective ridge. What is being sensed are not discrete events of turbulent eddies, but rather a continuum of possibly overlapping events forming a temporally stationary, essentially white process over the frequency range of interest. In other words, the convective eddies 186 is distributed over a range of length scales and hence temporal frequencies.

To calculate the power in the k−ω plane, as represented by a k−ω plot (see FIG. 14) of either of the signals, the array processor 194 determines the wavelength and so the (spatial) wavenumber k, and also the (temporal) frequency and so the angular frequency ω, of various of the spectral components of the stochastic parameter. There are numerous algorithms available in the public domain to perform the spatial/temporal decomposition of arrays of sensor units 124-130.

It should be appreciated that the present invention may use temporal and spatial filtering to precondition the signals to effectively filter out the common mode characteristics P_{common mode} and other long wavelength (compared to the sensor spacing) characteristics in the pipe 110 by differencing adjacent sensors and retain a substantial portion of the stochastic parameter associated with the flow field and any other short wavelength (compared to the sensor spacing) low frequency stochastic parameters.

In the case of suitable turbulent eddies 186 (see FIG. 13) being present, the power in the k−ω plane shown in a k−ω plot of FIG. 14 shows a convective ridge 200. The convective ridge 200 represents the concentration of a stochastic parameter that convects with the flow 108 and is a mathematical manifestation of the relationship between the spatial variations and temporal variations described above. Such a plot will indicate a tendency for k−ω pairs to appear more or less along a line 200 with some slope, wherein the slope indicates the flow velocity.

Once the power in the k−ω plane is determined, a convective ridge identifier 196 uses one or another feature extraction method to determine the location and orientation (slope) of any convective ridge 200 present in the k−ω plane. In one embodiment, a so-called slant stacking method is used, a method in which the accumulated frequency of k−ω pairs in the k−ω plot along different rays emanating from the origin are compared, each different ray being associated with a different trial convection velocity (in that the slope of a ray is assumed to be the flow velocity or correlated to the flow velocity in a known way). The convective ridge identifier 196 provides information about the different trial convection velocities, information referred to generally as convective ridge information.

The analyzer 198 examines the convective ridge information including the convective ridge orientation (slope). Assuming the straight-line dispersion relation given by k=ω/u, the analyzer 198 determines the flow velocity, Mach number and/or volumetric flow. The volumetric flow is determined by multiplying the cross-sectional area of the inside of the pipe with the velocity of the process flow 108.

For any embodiments described herein, the pressure sensors 124-130, including electrical strain gages, optical fibers and/or gratings among others as described herein, may be attached to the pipe by adhesive, glue, epoxy, tape or other suitable attachment means to ensure suitable contact between the sensor and the pipe. The sensors 124-130 may alternatively be removable or permanently attached via known mechanical techniques such as mechanical fastener, spring loaded, clamped, clam shell arrangement, strapping or other equivalents. Alternatively, the strain gages, including optical fibers and/or gratings, may be embedded in a composite pipe. If desired, for certain applications, the gratings may be detached from (or strain or acoustically isolated from) the pipe if desired.

It is also within the scope of the present invention that any other strain sensing technique may be used to measure the variations in strain in the pipe 110, such as highly sensitive piezoelectric, electronic or electric, strain gages attached to or embedded in the pipe. Accelerometers may be also used to measure the unsteady pressures. Also, other pressure sensors 124-130 may be used, as described in a number of the aforementioned patents, which are incorporated herein by reference in their entireties. In another embodiment, the sensor may comprise of piezofilm or strips (e.g. PVDF) as described in at least one of the aforementioned patent applications, which are incorporated herein by reference in their entireties.

While the illustrations show four sensors mounted or integrated in a tube of the coriolis meter, the invention contemplates any number of sensors in the array as taught in at least one of the aforementioned patent applications. Also the invention contemplates that the array of sensors 124-130 may be mounted or integrated with a tube of a coriolis meter having shape, such as pretzel shape, U-shaped (as shown), straight tube and any curved shape. The invention further contemplated providing an elongated, non-vibrating (or oscillating) portion that permits a greater number of sensors to be used in the array.

While the present invention describes an array of sensors for measuring the speed of sound propagating through the flow for use in interpreting the relationship between coriolis forces and the mass flow through a coriolis meter. Several other methods exists and may also be used, individually or in a combined manner. For example, for a limited range of fluids, an ultrasonic device could be used to determine speed of sound of the fluid entering. It should be noted that the theory indicates that the interpretation of coriolis meters will be improved for all fluids if the sound speed of the process fluid is measured and used in the interpretation. Thus, knowing that the sound speed of the fluid is 5000 ft/sec as it would be for a water like substance, compared to 1500 ft/sec as it would be for say supercritical ethylene, would improve the performance of a coriolis based flow and density measurement. These measurements could be performed practically using existing ultrasonic meters.

Another approach to determine speed of sound of the fluids is to measure the resonant frequency of the acoustic modes of the flow tubes. When installed in a flow line, the cross sectional area changes associated with the transition from the pipe into the typically much smaller flow tubes creates a significant change in acoustic impedance. As a result of this change in impedance, the flow tube act as somewhat of a resonant cavity. By tracking the resonant frequency of this cavity, one could determine the speed of sound of the fluid occupying the cavity. This could be performed with a single pressure sensitive device, mounted either on the coriolis meter, of on the piping network attached to the coriolis meter.

In a more general aspect, the present invention contemplates the ability of augmenting the performance of a coriolis meter using any method or means for measuring the gas void fraction of the fluid flow.

In one embodiment of the present invention, as shown in FIG. 13, each of the pressure sensors 124-130 may include a piezoelectric film sensor to measure the unsteady pressures of the fluid flow 108 using either technique described hereinbefore. The piezoelectric film sensors include a piezoelectric material or film to generate an electrical signal proportional to the degree that the material is mechanically deformed or stressed. The piezoelectric sensing element is typically conformed to allow complete or nearly complete circumferential measurement of induced strain to provide a circumferential-averaged pressure signal. The sensors can be formed from PVDF films, co-polymer films, or flexible PZT sensors, similar to that described in “Piezo Film Sensors Technical Manual” provided by Measurement Specialties, Inc., which is incorporated herein by reference. A piezoelectric film sensor that may be used for the present invention is part number 1-1002405-0, LDT4-028K, manufactured by Measurement Specialties, Inc.

Piezoelectric film (“piezofilm”), like piezoelectric material, is a dynamic material that develops an electrical charge proportional to a change in mechanical stress. Consequently, the piezoelectric material measures the strain induced within the pipe 110 due to unsteady pressure variations (e.g., acoustic waves) within the process mixture 108. Strain within the pipe 110 is transduced to an output voltage or current by the attached piezoelectric sensor. The piezoelectrical material or film may be formed of a polymer, such as polarized fluoropolymer, polyvinylidene fluoride (PVDF). The piezoelectric film sensors are similar to that described in U.S. patent application Ser. No. 10/712,818 (CiDRA Docket No. CC-0675), U.S. patent application Ser. No. 10/712,833 (CiDRA Docket No. CC-0676), and U.S. patent application Ser. No. 10/795,111 (CiDRA Docket No. CC-0732), which are incorporated herein by reference in their entireties.

Another embodiment of the present invention include a pressure sensor such as pipe strain sensors, accelerometers, velocity sensors or displacement sensors, discussed hereinafter, that are mounted onto a strap to enable the pressure sensor to be clamped onto the pipe 110. The sensors may be removable or permanently attached via known mechanical techniques such as mechanical fastener, spring loaded, clamped, clam shell arrangement, strapping or other equivalents. These certain types of pressure sensors, it may be desirable for the pipe 110 to exhibit a certain amount of pipe compliance.

Instead of single point pressure sensors 124-130, at the axial locations along the pipe 110, two or more pressure sensors may be used around the circumference of the pipe 110 at each of the axial locations. The signals from the pressure sensors around the circumference at a given axial location may be averaged to provide a cross-sectional (or circumference) averaged unsteady acoustic pressure measurement. Other numbers of acoustic pressure sensors and annular spacing may also be used. It should be appreciated that averaging multiple annular pressure sensors reduces noises from disturbances and pipe vibrations and other sources of noise not related to the one-dimensional acoustic pressure waves in the pipe 110, thereby creating a spatial array of pressure sensors to help characterize the one-dimensional sound field within the pipe 110.

The pressure sensors 124-130 described herein may be any type of pressure sensor, capable of measuring the unsteady (or ac or dynamic) pressures within a pipe 110, such as piezoelectric, optical, capacitive, resistive (e.g., Wheatstone bridge), accelerometers (or geophones), velocity measuring devices, displacement measuring devices, etc. If optical pressure sensors are used, the sensors 124-130 may be Bragg grating based pressure sensors, such as that described in U.S. patent application Ser. No. 08/925,598, entitled “High Sensitivity Fiber Optic Pressure Sensor For Use In Harsh Environments”, filed Sep. 8, 1997, now U.S. Pat. No. 6,016,702, and in U.S. patent application Ser. No. 10/224,821, entitled “Non-Intrusive Fiber Optic Pressure Sensor for Measuring Unsteady Pressures within a Pipe”, which are incorporated herein by reference in their entireties. In an embodiment of the present invention that utilizes fiber optics as the pressure sensors, they may be connected individually or may be multiplexed along one or more optical fibers using wavelength division multiplexing (WDM), time division multiplexing (TDM), or any other optical multiplexing techniques.

In certain embodiments of the present invention, a piezo-electronic pressure transducer may be used as one or more of the pressure sensors 124-130 and it may measure the unsteady (or dynamic or ac) pressure variations inside the pipe or tube 110 by measuring the pressure levels inside of the tube 110. These sensors may be ported within the pipe 110 to make direct contact with the mixture 108. In an embodiment of the present invention, the sensors comprise pressure sensors manufactured by PCB Piezotronics. In one pressure sensor there are integrated circuit piezoelectric voltage mode-type sensors that feature built-in microelectronic amplifiers, and convert the high-impedance charge into a low-impedance voltage output. Specifically, a Model 106B manufactured by PCB Piezotronics is used which is a high sensitivity, acceleration compensated integrated circuit piezoelectric quartz pressure sensor suitable for measuring low pressure acoustic phenomena in hydraulic and pneumatic systems. It has the unique capability to measure small pressure changes of less than 0.001 psi under high static conditions. The 106B has a 300 mV/psi sensitivity and a resolution of 91 dB (0.0001 psi).

The pressure sensors incorporate a built-in MOSFET microelectronic amplifier to convert the high-impedance charge output into a low-impedance voltage signal. The sensor is powered from a constant-current source and can operate over long coaxial or ribbon cable without signal degradation. The low-impedance voltage signal is not affected by triboelectric cable noise or insulation resistance-degrading contaminants. Power to operate integrated circuit piezoelectric sensors generally takes the form of a low-cost, 24 to 27 VDC, 2 to 20 mA constant-current supply. A data acquisition system of the present invention may incorporate constant-current power for directly powering integrated circuit piezoelectric sensors.

Most piezoelectric pressure sensors are constructed with either compression mode quartz crystals preloaded in a rigid housing, or unconstrained tourmaline crystals. These designs give the sensors microsecond response times and resonant frequencies in the hundreds of kHz, with minimal overshoot or ringing. Small diaphragm diameters ensure spatial resolution of narrow shock waves. The output characteristic of piezoelectric pressure sensor systems is that of an AC-coupled system, where repetitive signals decay until there is an equal area above and below the original base line. As magnitude levels of the monitored event fluctuate, the output remains stabilized around the base line with the positive and negative areas of the curve remaining equal.

It is also considered within the scope of the present invention that any strain sensing technique may be used to measure the variations in strain in the pipe, such as highly sensitive piezoelectric, electronic or electric, strain gages and piezo-resistive strain gages attached to the pipe 110. Other strain gages include resistive foil type gages having a race track configuration similar to that disclosed U.S. patent application Ser. No. 09/344,094, filed Jun. 25, 1999, now U.S. Pat. No. 6,354,147, which is incorporated herein by reference. The invention also contemplates strain gages being disposed about a predetermined portion of the circumference of pipe 110. The axial placement of and separation distance ΔX₁, ΔX₂ between the strain sensors are determined as described herein above.

It should appreciated that while the present invention disclosed herein is shown as being used when the fluid 108 flowing within the pipe 110 is slugging, i.e. not filling the entire pipe 110, the present invention may also be used when the pipe is primarily full. Also, it should be appreciated that the flow velocity Uₘᵢₓ of the fluid and/or density of the fluid ρₘᵢₓ can be measured with or without a full pipe 110 as illustrated in FIGS. 3b, 5 and 7. Moreover, while a number of preferred embodiments have been described herein, any combination of the features described herein may be used.

It is also within the scope of the present invention that any other strain sensing technique may be used to measure the variations in strain in the tube 110, such as highly sensitive piezoelectric, electronic or electric, strain gages attached to or embedded in the tube 14. While a number of sensor have been described, one will appreciate that any sensor the measures the speed of sound propagating through the fluid may be used with the present invention, including ultrasonic sensors.

The coriolis meter described herein before may be any known coriolis meter, such as two inch bent tube coriolis meter manufactured my MicroMotion Inc. and a two in straight tube coriolic meter manufactured by Endress & Hauser Inc. The coriolis meters comprise a pair of bent tubes (e.g. U-shaped, pretzel shaped) or straight tubes.

While a particular density meter was described for an embodiment, the present invention contemplates any density meter may be used in the embodiments. Similarly, while a particular meter was provided to determine speed of sound propagating through the fluid flow 108, the present invention contemplates any SOS measuring device may be used. The dimensions and/or geometries for any of the embodiments described herein are merely for illustrative purposes and, as such, any other dimensions and/or geometries may be used if desired, depending on the application, size, performance, manufacturing requirements, or other factors, in view of the teachings herein. It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What is claimed is:

1. An apparatus for determining at least one characteristic of a fluid flowing within a pipe, wherein the pipe is at least one of completely filled and partially filled and wherein the fluid includes a gas component and a liquid component, the apparatus comprising:
a first sensing device for generating first sensor data responsive to a first parameter of the fluid flow;
a second sensing device for generating second sensor data responsive to a second parameter of the fluid flow; and
a processing device communicated with at least one of said first sensing device and said second sensing device to receive said first sensor data and said second sensor data, wherein said processing device processes said first sensor data and said second sensor data to generate flow data responsive to the at least one characteristic of the fluid.

2. The apparatus of claim 1, wherein said first sensing device includes at least one ultrasonic sensing device.

3. The apparatus of claim 1, wherein said first sensing device includes at least one of an array of ultrasonic sensors and an array of strain sensors.

4. The apparatus of claim 1, wherein said first sensor data is responsive to at least one of a fluid flow velocity, a gas phase flow velocity, an oil phase flow velocity, a water phase flow velocity.

5. The apparatus of claim 1, wherein said second sensing device includes at least one strain sensing device.

6. The apparatus of claim 1, wherein said second sensing device is a density meter and wherein said second sensor data includes at least one of a fluid density, a liquid component density, a gas density, a water density, an oil density and a water cut.

7. The apparatus of claim a, wherein said at least one characteristic of the fluid includes at least one of a volumetric flow rate of a water component of the fluid, a volumetric flow rate of an oil component of the fluid, a volumetric flow rate of a gas component of the fluid and a volumetric flow rate of the fluid.

8. A method for determining at least one characteristic of a fluid flowing within a pipe, wherein the fluid includes a gas component and a liquid component, the method comprising:
determining if the gas component is present in a predefined region of the pipe;
generating fluid data responsive to whether the gas component is present in said predefined region of the pipe; and
processing said fluid data to identify the at least one characteristic of the fluid.

9. The method of claim 8, wherein the liquid component includes a water component and an oil component and wherein said generating includes determining a density of said oil component, a density of said water component, a density of said gas component and a water cut of the fluid.

10. The method of claim 9, wherein if the gas component is present in said predefined region of the pipe, said generating further includes determining at least one of a gas void fraction, a flow velocity of the fluid and a density of the fluid.

11. The method of claim 9, wherein said generating further includes generating fluid data responsive to the relationships,
ρₘᵢₓ=φ_{O}ρ_{O}+φ_{W}ρ_{W}+φ_{G}ρ_{G},
φ_{O}+φ_{W}+φ_{G}=1.
where ρₘᵢₓ is the density of the fluid, ρ_{O} is the density of the oil component, ρ_{W} is the density of the water component, ρ_{G} is the density of the gas component, φ_{O} is the phase fraction of the oil component, φ_{W} is the phase fraction of the water component and φ_{G} is the phase fraction of the gas component.

12. The method of claim 9, wherein if the gas component is not present in said predefined region of the pipe, said generating further includes determining a density of the fluid, a flow velocity of the fluid and a water cut of the fluid.

13. The method of claim 9, wherein said generating includes generating fluid data responsive to the relationships,
ρₘᵢₓ=φ_{L}ρ_{L}+φ_{G}ρ_{G},
ρ_{L}=W_{c}ρ_{W}+(1−W_{c})ρ_{O}, and
φ_{L}+φ_{G}=1.
where ρₘᵢₓ is the density of the fluid, ρ_{L} is the density of the liquid component, ρ_{W} is the density of the water component, ρ_{G} is the density of the gas component, ρ_{O} is the density of the oil component, φ_{L} is the phase fraction of the liquid component, φ_{G} is the phase fraction of the gas component and W_{c} is the water cut.

14. The method of claim 8, wherein said generating further includes determining at least one of a flow velocity of the fluid and a density of the fluid.

15. The method of claim 9, wherein said generating further includes determining at least one of a flow velocity of the fluid and a density of the fluid.

16. The method of claim 9, wherein if the gas component is not present in said predefined region of the pipe, said generating further includes determining a water cut of the fluid.

17. The method of claim 9, wherein said generating further includes generating a density of the fluid and a flow velocity of the fluid.

18. The method of claim 17, wherein said generating further includes generating an ultrasonic sensor flow velocity via at least one ultrasonic sensor and a strain sensor flow velocity via at least one strain sensor.

19. The method of claim 18, wherein said generating further includes determining an ultrasonic sensor flow velocity quality and a strain sensor flow velocity quality and comparing said ultrasonic sensor flow velocity quality with said strain sensor flow velocity quality to identify which of said ultrasonic sensor flow velocity and said strain sensor flow velocity is a higher quality flow velocity.

20. The method of claim 19, wherein said processing includes processing said fluid data using said higher quality flow velocity.
